(19) United States
(12) Patent Application Publication
(10) Pub. No.: US 2004/0054041 A1
(43) Pub. Date: Mar. 18, 2004

(54) NOVEL POLYMER BINDER SYSTEMS COMPRISING IONIC LIQUIDS

(76) Inventor: Friedrich Georg Schmidt, Haltern am See (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/250,753

(22) PCT Filed: Dec. 5, 2001
(86) PCT No.: PCT/EP01/14237

(30) Foreign Application Priority Data
Jan. 8, 2001 (DE) 10100455.9

(51) Int. Cl. C08K 5/34

(52) U.S. Cl. 524/99; 524/106

(57) ABSTRACT

The invention relates to mixtures of (meth)acrylate polymers and ionic liquids.

The invention relates to mixtures of polymers and ionic liquids.

Many polymers, for example various polyaramides, ionomers, polyesters, polyamides, polyether (ether) ketones, can be processed only by means of particular processes or only with difficulty. In some cases, thermoplastic processing of the polymer materials as such is not possible at all without decomposition of the polymer chain occurring.

Polymers can frequently be made processible only by mixing plasticizers into them.

Many plasticizers are not suitable for the high temperature range. This is due, for example, to the plasticizers being too volatile or being incompatible with the polymer.

Especially for polymers bearing ionic groups, it is frequently not possible to find suitable noncorrosive plasticizers which have no effect or only a positive effect on the conductivity.

### PRIOR ART

A mixture of cellulose and a salt hydrate melt of LiClO₄/LiI.xH₂O or LiCIO₄/Mg(ClO₄)₂.xH₂O, in which the cellulose is present in swelled or dissolved form is described in the literature, and the crystal structure of the regenerated cellulose, which is dependent on the composition of the previously prepared solution, is examined. (Fischer, S. et al. ACS Symp. Ser. (1999) 737, 143).

Polymer extractions using chloroaluminate salts which are molten at room temperature are also described in the literature (Wilkes, John S. et al., Proc.-Electrochem. Soc. (2000), 9941 (Molten Salts XII) 65; Proc.-Electrochem. Soc. (2000), 9941 (Molten Salts XII), 65).

These publications thus describe a mixture of polymers (cellulose) and inorganic salts or an inorganic ionic liquid.

Gel electrolytes can, according to, for example, Fuller et al. (J. Electrochem. Soc. (1997), 144(4), L67 and J. Electroanal. Chem. (1998) 459(1), 29), be prepared from fluorinated copolymers (polyvinylidene fluoride-hexafluoropropyl copolymers) and ionic liquids based on imidazolium derivatives with triflate or tetrafluoroborate counterions.

The following publications describe mixtures of polymers and ionic compounds (liquids) in which the polymers are either not functionalized or functionalized with groups which do not allow further salt/ion formation. These polymers therefore have no external charge.

JP 10265673 describes the preparation of polymeric, solid electrolytes by solidifying ionic liquids by means of, for example, polymerization of hydroxyethyl methacrylate and ethylene glycol dimethacrylate in the presence of the ionic liquids. The film obtained displays ionic conductivity.

In Electrochim. Acta (2000), 45(8-9), 1265, Noda et al. state that particular vinyl monomers can be polymerized in salt melts which are liquid at room temperature and comprise 1-ethyl-3-methylimidazolium tetrafluoroborate or 1-butylpyridinium tetrafluoroborate and give transparent, highly conductive and mechanically stable polymer electrolyte films.

JP 10265674 describes composites comprising polymers, e.g. polyacrylonitrile or polyethylene oxide, and ionic liquids. The ionic liquids are composed of Li salts (e.g. LiBF₄) or cyclic amidines or onium salts of pyridine (e.g. 1-ethyl-3-methylimidazolium tetrafluoroborate). Applications indicated are solid electrolytes, antistatics and shielding compositions.

Fuller et al. (Molten Salt Forum (1998), 5-6 (Molten Salt Chemistry and Technology 5), 605) describe mixtures of ionic liquids or other imidazolium salts with polymers. These blends display high conductivity, thermal stability, etc., for applications in batteries, fuel cells or capacitors as highly conductive polymer electrolytes.

Humphrey et al. (Book of Abstracts, 215th ACS National Meeting, Dallas. March 29-April 2 (1998), CHED-332, ACS, Washington D.C.) describe the dissolution and extraction of polymers by means of salt melts which are liquid at room temperature and comprise aluminum chloride and an organic chloride salt. The Lewis acidity of the ionic liquids can be adjusted and addition of hydrogen chloride turns them into superacids.

Watanabe et al. (Solid State Ionics (1996), 86-88 (Pt. 1), 353) state that salt mixtures which are liquid at temperatures below 100° C. and comprise trimethylammonium benzoate, lithium acetate and lithium bis(tri-fluoromethylsulfonyl)imide give compatible mixtures with polyacrylonitrile and polyvinyl butyral. These mixtures allow the production of films.

Ogata et al. (Synth. Met. (1995), 69(1-3), 521) describe mixtures of polycation salts (e.g. poly(1-butyl-4-vinylpyridinium) bromide, 1,6-hexane dichloride-N,N,N′,N′-tetramethyl-1,3-propylenediamine copolymer) with salt melts comprising aluminum chloride. The mixtures give viscoelastic films and display thermal conductivities which are higher and less temperature-dependent than those of polymer electrolyte systems based on polyethylene oxide. Similar results have been obtained by Rikukawa et al. using salts comprising aluminum chloride and 1-butylpyridinium salts (Mater. Res. Soc. Symp. Proc. (1993), 293 (Solid State Ionics III), 135).

For many applications, it would be desirable to obtain a high conductivity of the polymer; this is not possible or possible to only an unsatisfactory extent when using the previously described systems.

It is therefore an object of the present invention to provide polymer systems in admixture with ionic liquids which can be prepared easily and combine a good conductivity with good processibility.

It has surprisingly been found that polymers having ionic or strongly polar monomer structures can be improved in terms of, for example, their electrical properties and their processibility by addition of ionic liquids.

The present invention accordingly provides mixtures comprising one or more (meth)acrylate polymers functionalized by sulfonate, carboxyl or quaternary amino groups and an ionic liquid.

The mixtures of the invention may comprise one or more polymers, be it as blend, copolymer or physical mixture.

In a particular embodiment of the present invention, the (meth)acrylate polymer is a copolymer of at least one (meth)acrylate monomer and at least one olefinically unsaturated monomer.

The olefinically unsaturated monomer can be functionalized by carboxyl, carboxylate, tert-amino, quaternary amino, sulfonate and/or sulfonic acid groups in various ways in different variants of the invention.

For the purposes of the present invention, ionic liquids are salts which are liquid at low temperatures. They represent a novel class of substance having a nonmolecular ionic character. In contrast to classical salt melts, which are high-melting, highly viscous and very corrosive media, ionic liquids are liquid at low temperatures (<80° C.) and have a relatively low viscosity. [K. R. Seddon, J. Chem. Technol. Biotechnol. 1997, 68, 351-356; K. R. Seddon, Kinet. Catal. 1996, 37, 693-697].

Ionic liquids (IL) have been known for some years in the field of catalysis from WO 00/20115 and WO 00/16902. Ionic liquids are salt melts which preferably solidify only at temperatures below room temperature. A general review of this subject may be found, for example, in Welton (Chem. Rev. 1999, 99, 2071). The ionic liquids are mostly imidazolium or pyridinium salts.

The ionic liquid present in the mixtures of the invention is preferably a salt having a cation selected from the group consisting of imidazolium ions, pyridinium ions, ammonium ions and phosphonium ions of the following structures,

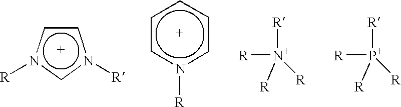

where R, R′=H, identical or different alkyl, olefin or aryl groups, with the proviso that R and R′ are different, and an anion from the group consisting of BF₄⁻ ions, alkylborate ions, BEt₃Hex ions where Et=an ethyl group and Hex=a hexyl group, halophosphate ions, PF₆⁻ions, nitrate ions, sulfonate ions, alkylsulfonate and arylsulfonate ions, hydrogensulfate ions and chloroaluminate ions.

A distinction between salt melts and ionic liquids at a melting point of 80° C. can be justified by the step improvement in the range of applications of liquid salts below this temperature: even if a few examples in which high-temperature salt melts were used successfully as reaction media in synthetic applications are known [a) W. Sundermeyer, Angew. Chem. 1965, 77, 241-258; Angew. Chem. Int. Ed. Engl. 1965, 4, 222-329; b) W. Sundermeyer, Chemie in unserer Zeit 1967, 1, 150-157; c) S. V. Volkov, Chem. Soc. Rev. 1990, 19, 21-28], only a liquid range to below 80° C. allows the wide-ranging replacement of conventional, organic solvents by ionic liquids.

Although some representatives have been known since 1929, ionic liquids have only been examined intensively as solvents for chemical reactions in the last 15 years. The publications which have appeared since then show that the replacement of organic solvents by an ionic liquid can lead to notable improvements in reactivity and selectivity in synthetic and catalytic applications [T. Welton, Chem. Rev. 1999, 99, 2071-2083]. Examples are the published works on Friedel-Crafts alkylation [K. R. Seddon, J. Chem. Technol. Biotechnol. 1997, 68, 351-356; K. R. Seddon, Kinet. Catal. 1996, 37, 693-697] and Friedel-Crafts acylation [W. Sundermeyer, Angew. Chem. 1965, 77, 241-258; Angew. Chem. Int. Ed. Engl. 1965, 4, 222-329; W. Sundermeyer, Chemie in unserer Zeit 1967, 1, 150-157; S. V. Volkov, Chem. Soc. Rev. 1990, 19, 21-28], on various hydrogenations [T. Welton, Chem. Rev. 1999, 99, 2071-2083] hydroformylations [H. Waffenschmidt, P. Wasserscheid, D. Vogt, W. Keim, J. Catal. 1999, 186, 481; H. Waffenschmidt, P. Wasserscheid, W. Keim, Deutsche Patentanmeldung 19901524.4, 1999; V. R. Koch, L. L. Miller, R. A. Osteryoung, J. Am. Chem. Soc. 1976, 98, 5277-5284; A. A. K. Abdul-Sada, M. P. Atkins, B. Ellis, P. K. G. Hodgson, M. L. M. Morgan, K. R. Seddon (BP Chemicals), WO 95/21806, 1995 [Chem. Abstr. 1996, 124, P8381z]; F. G. Sherif, L-J. Shyu, C. C. Greco, A. G. Talma, C. P. M. Lacroix (Akzo Nobel N. V.), WO 9803454 A1, 1998 [Chem. Abstr. 1998, 128, P140512e]] and on the Heck reaction [C. J. Adams, M. J. Earle, G. Roberts, K. R. Seddon, Chem. Commun. 1998, 2097-2098] and on oligomerization and polymerization reactions [Ellis, W. Keim, P. Wasserscheid, Chem. Comm. 1999, 337-338; Y. Chauvin, L. Muβmann, H. Olivier, Angew. Chem. 1995, 107, 2941-2943; Angew. Chem. Int. Ed. Engl. 1995, 34, 2698-2700; P. A. Z. Suarez, J. E. L. Dullius, S. Einloft, R. F. de Souza, J. Dupont, Inorg. Chim. Acta 1997, 255, 207-209; P. A. Z. Suarez, J. E. L. Dullius, S. Einloft, R. F. de Souza, J. Dupont, Polyhedron, 1996, 15, 1217-1219] in which ionic liquids are successfully used as catalysts or solvents for the reactions. In these reactions, the chemical and physical properties of the ionic liquids used can be optimized for the particular application by selection of various cations and anions. For this reason, ionic liquids are also referred to as “designer solvents” [G. W. Parshall, J. Am. Chem. Soc. 1972, 94, 8716-8719; b) N. Karodia, S. Guise, C. Newlands, J.-A. Andersen, Chem. Commun. 1998, 2341-2342; c) Y. Chauvin, H. Olivier, L. Muβmann, FR 95/14,147, 1995 [Chem. Abstr. 1997, 127, P341298k]].

Ionic liquids form two phases with many organic product mixtures. In these cases, a multiphase reaction makes it simple to separate off the product and recycle the homogeneous catalyst. The negligible vapor pressure of ionic liquids also makes it possible for the product to be separated off by distillation without azeotrope formation. In some cases, the catalyst is stabilized by the ionic liquid under the conditions of distillation and can be used for further catalytic reactions with virtually unchanged activity [H. Waffenschmidt, P. Wasserscheid, D. Vogt, W. Keim, J. Catal. 1999, 186, 481; H. Waffenschmidt, P. Wasserscheid, W. Keim, DE 19 90 1524].

The (meth)acrylate polymers used in the mixture of the invention can be functionalized with the abovementioned functional groups in various ways:

functionalization of the (meth)acrylate monomer, using one or more functionalized and unfunctionalized monomers for the polymerization in each case;

functionalization of the olefinically unsaturated monomer in the case of copolymers.

If the (meth)acrylate polymer is functionalized by tertiary amino groups, the desired quaternary amino groups can be obtained by reacting this polymer with an acid, preferably an organic monofunctional, bifunctional, trifunctional or polyfunctional carboxylic acid.

If the (meth)acrylate polymer is functionalized by carboxylate groups, the desired carboxyl groups can be obtained by reacting this polymer with an amino compound, preferably an organic monofunctional, bifunctional, trifunctional or polyfunctional amine compound.

If the (meth)acrylate polymer is functionalized by sulfonic acid groups, the desired sulfonate groups can be obtained by reacting this polymer with an amino compound, preferably an organic monofunctional, bifunctional, trifunctional or polyfunctional amine compound.

Preparation of the Mixtures of the Invention:

The mixtures of the invention can be prepared by customary methods known to those skilled in the art; examples which may be mentioned are:

mechanical blending by mixing the ionic liquid and the (meth)acrylate polymers by means of an extruder or stirred vessel at appropriate temperatures

dissolving the polymers in the ionic liquid at room temperature or elevated temperatures

precipitation of the components of the mixture from a solution in which they are both(/all) present by means of a nonsolvent or by lowering the temperature

salting out the components of the mixture from a solution in which they are both(/all) present

mixing in a stirred vessel with subsequent removal of an initially added solvent.

The invention further provides for the use of the mixtures of the invention in electrical and electronic components, as conductive or antistatic binders or adhesives, for processing of polymers by extrusion or injection molding.

In these applications, the mixtures of the invention can be used in admixture with other polymers or on their own.

The mixtures of the present invention are novel conductive or antistatic binder or adhesive systems.

Conductive binder systems and adhesives are nowadays produced by addition of specific conductive fillers. Molded compositions, surface coatings, rubber and foams are made antistatic by incorporation of conductivity-improving fillers or fibers (carbon black, graphite) or low molecular weight salts such as potassium formate. Electrically conductive adhesives have in the past been employed as alternatives or supplements to soft solders, particularly in electronics. Base polymers used are predominantly epoxy resins; in addition, adhesive systems based on cyanoacrylate, silicone and polyimide are known. Further known conductivity-increasing additives are gold, silver, copper or nickel in platelet or floc form, likewise, for example, silver-coated glass beads (EP 0 195 859).

Furthermore, with regard to polymer materials which have been made conductive for electronic applications, the prior art also discloses materials whose conductivity has been increased either by addition of intrinsically conductive polymer materials (e.g. BF4-doped poly(ethoxythiophene) as additive for heat-sealable antistatic films (DE 42 19 410) or by addition of particles or antistatic or conductive fibers (acrylate ester polymer emulsions comprising conductive acrylate fibers with absorbed Cu salts (JP 62129371)).

JP 46040419 describes hot adhesive compositions which comprise hydroxy-, carboxy-, epoxy- or amino-containing ethylene copolymers, isocyanate derivatives and up to 10% of an amine salt, e.g. hexahydromethylaniline acetate or zinc N-ethyl-N-phenyldithiocarbamate, and display reduced aging and a better adhesive action even after washing of adhesively bonded textiles.

It has surprisingly been found that it is possible to adjust the processing, electrical and thermal properties of polymers based on (meth)acrylate copolymers or of a copolymer within wide limits by addition of an ionic liquid.

Processibility

The increase in the flowability of the melts of this polymer is due to the solvent-like character of the ionic liquids, with a particular advantage being the nonvolatility of the ionic liquids even at the processing temperatures for the blends. Thus, processing temperatures at which the previously used plasticizers or processing aids have an excessively high vapor pressure and lead to gas evolution can be employed or the polymers can be processed at lower temperatures due to the plasticizing action.

Electrical Properties

The electrical properties of these polymer/plasticizer (blend) systems can be modified within a wide range by means of ionic liquids as a result of the introduction of the ionic groups. Antistatic or sometimes even semiconducting properties of the polymer materials can thus be achieved.

Flowability

The flowability of the polymer materials in the molten state is increased by the use of ionic liquids as plasticizers.

Adhesive Behavior

The adhesion of appropriate blends of polymers and ionic liquids to surfaces which are polar or have been swelled or partially dissolved by the ionic liquids is improved by the presence of ionic groups.

Owing to their nonvolatile and ionic character (vapor pressure not measurable) and their particular solvent properties, ionic liquids can be used as plasticizers or solvents, particularly for polymers or substances which are insoluble or insufficiently soluble in organic or aqueous solvents. If crosslinked or crosslinkable polymers are used in the mixture, the ionic liquid likewise serves as plasticizer which reduces the glass transition temperature.

Good processibility of the polymer materials is particularly important in the injection molding of thermoplastics. The processibility can be restricted when using polymers having strongly polar or ionic functional groups because of the intramolecular and intermolecular interactions. The use of ionic liquids as plasticizers reduces the interactions between the functional groups bound to the polymer and thus improves processibility.

In the case of polymers to be spun into fibers, the ionic liquid can aid the spinning process or even make it possible. Owing to the lowering of the melt viscosity by the addition of ionic liquids, the processing window for the spinning process can be widened; the same applies to film production or other extrusion processes.

The ionic liquids present as plasticizing processing aids can, provided that they are miscible with water or another solvent which is incompatible with the polymer, also be extracted from the polymers after processing, resulting in changes in the structure and properties of the polymer.

The use of the mixtures of the invention in electronic components is unknown and is, owing to the variable electrical and thermal properties of these systems, particularly advantageous.

In preferred embodiments of the mixtures of the invention, the mixture comprises, in addition to the ionic liquid,

a) 30-99% by weight of a (meth)acrylate copolymer which is functionalized by tertiary and/or quaternary amino groups, and

b) 70-1% by weight of an organic monofunctional, bifunctional, trifunctional and/or polyfunctional carboxylic acid,

or

c) 30-90% by weight of a (meth)acrylate copolymer which is functionalized by carboxylate and/or carboxyl groups, and

d) 70-1% by weight of an organic monofunctional, bifunctional, trifunctional and/or polyfunctional compound containing tertiary or quaternary amino groups.

The (meth)acrylate polymer can, as mentioned above, be a polymer comprising one or more (meth)acrylate building blocks or a copolymer comprising these building blocks together with one or more functionalized olefinically unsaturated monomers.

In addition to the components a) and b) or c) and d), the mixture of the invention can optionally contain 40-80% by weight, based on the sum of a) and b) or c) and d), of a plasticizing agent or an agent which influences the melting and flow behavior e).

Amine-Functionalized Copolymers (a):

If monomers containing amino groups are used, the proportion of the monomer containing amino groups in the copolymer is preferably from 30 to 80% by weight. Preferred components a) are esters and amides of acrylic and/or methacrylic acid which, in the salt form, have the structure

CH₂═CR—CO-A-Alk-N⁺R′₃X⁻

where R is a hydrogen atom or an alkyl group having 1-12 carbon atoms, preferably methyl, A is an oxygen atom or an imino group, preferably —NH—, Alk is a straight-chain or branched alkylene group, preferably having from 2 to 8 carbon atoms, R′ are identical or different organic radicals having up to 22 carbon atoms, in particular alkyl, aryl or aralkyl radicals, where no more than two of the radicals R′ are hydrogen atoms. X⁻ is the acid anion which can be an anionic organic group (R—COO⁻, R—SO₃⁻), halide (F⁻, Br⁻, Cl⁻) or SO₃²⁻, SO₄²⁻, CO₃²⁻.

Suitable amino-containing monomers for component a) or d) having a tert-amino group are:

dimethylaminoethyl acrylate and methacrylate,

diethylaminoethyl acrylate and methacrylate,

dibutylaminoethyl acrylate and methacrylate,

morpholinoethyl acrylate and methacrylate,

piperidinoethyl acrylate and methacrylate,

dimethylamino-2-propyl acrylate and methacrylate,

dimethylaminoneopentyl acrylate and methacrylate,

dimethylaminoethylacrylamide and dimethylaminoethylmethacrylamide,

diethylaminoethylacrylamide and diethylaminoethylmethacrylamide,

dibutylaminoethylacrylamide and dibutylaminoethylmethacrylamide,

morpholinoethylacrylamide and morpholinoethylmethacrylamide,

piperidinoethylacrylamide and piperidinoethylmethacrylamide,

dimethylamino-2-propylacrylamide and dimethylamino-2-propylmethacrylamide,

dimethylaminoneopentylacrylamide and dimethylaminoneopentylmethacrylamide.

Monomers having a plurality of amino groups, e.g. derivatives of polyethylenimine, and also monomers bearing one or more quaternary ammonium groups are suitable.

These include, for example,

N,N-dimethyl-N-(2-methacryloyloxyethyl)aminoacetic acid betaine,

N, N-dimethyl-N-(2-methacryloylaminopropyl)aminoacetic acid betaine,

acryloxyethyltrimethylammonium and methacryloxyethyltrimethylammonium chloride,

acryloxyethyltrimethylammonium and methacryloxyethyltrimethylammonium methosulfate,

acrylamidoethyltrimethylammonium and methacrylamidoethyltrimethylammonium chloride.

Since quaternary ammonium compounds having carboxylate anions are difficult to obtain, when using the latter monomers it is difficult to make use of the plasticizing action of higher carboxylate anions.

Among the alkyl esters of acrylic acid and/or methacrylic acid, preference is given to those having from 4 to 12 carbon atoms in the alkyl radical, especially the esters of acrylic acid. n-Butyl, n-hexyl, n-octyl, 2-ethylhexyl, n-decyl and n-dodecyl acrylates are particularly suitable. The lower esters of acrylic and/or methacrylic acid are generally used only as comonomers together with the higher esters.

In determining the proportion of the component containing amine groups, account has to be taken of the desired solubility in water; on the other hand, a sufficient proportion of the plasticizing alkyl acrylate or methacrylate has to be ensured. If the monomers used for forming the copolymer do not allow these two properties to be achieved simultaneously at any mixing ratio, recourse can be made to a plasticizer, i.e. component c). A sufficiently high proportion of monomers containing amino groups enables, for example, water-based binder systems to be prepared. If a lower proportion of monomers containing amine groups is selected, solvent-based systems are obtained.

As solvents for the solvent-based systems, it is possible to use individual substances or mixtures selected from among: alkyl alcohols (e.g. ethanol, isopropanol), ketones (e.g. acetone, MEK) and other solvents which can easily be removed. Sometimes it is also possible to use solvents which remain in the system, e.g. diols (1,2- or 1,3-propanediol, butanediol) or other polar solvents such as diglyme, etc.

Further comonomers can also be incorporated in the copolymers, as long as, for example, they do not reduce the water-solubility to an unacceptable extent or increase the hardness to an unacceptable extent. Examples are acrylamide and/or methacrylamide, hydroxyalkyl esters and polyalkylene glycol esters of acrylic and/or methacrylic acid, ethylene, vinyl acetate, vinyl propionate and vinylpyrrolidone. The concomitant use of these monomers is generally not necessary for preparing usable binder systems; they are usually present in a proportion of less than 20%.

The copolymer can be generated in the salt form by free-radical copolymerization of the neutralized amino monomers with the other monomer constituents in aqueous solution. However, preference is given to firstly preparing the unneutralized copolymer by using the base form of the monomer corresponding to the monomer having an ammonium salt group instead of the salt form of the monomer. The free-radical polymerization of these monomer mixtures can be carried out using various polymerization processes which have been known for a long time, e.g. polymerization in water or in organic solvents, polymerization in bulk and, since the copolymers in the base form are less soluble in water, emulsion polymerization in the aqueous phase and also “inverse bead polymerization” in an “organic phase”. The organic polymer solutions and aqueous polymer dispersions can be converted into powder products by, for example, spray drying. The bulk polymers are melted in an extruder and processed to produce fine granules.

The molecular weight of the copolymer influences the viscosity of the aqueous or solvent-based solution of the binder as a function of the concentration, based on the liquid component. It is preferably in a range from 100 to 2.5 million. The viscosity of the aqueous or solvent-based solution of the copolymer should be not more than 10 000 Pa·s, preferably from 10 mPa·s to 1 000 Pa·s, with the polymer content of the solution advantageously being from 20 to 80% by weight.

However, the stickiness of the copolymer depends not only on the amount of alkyl acrylates or methacrylates present in it, but also on the type of amino-containing monomer. Thus, a relatively long alkyl radical having up to about 10 carbon atoms as link between the unsaturated polymerizable group and the amino group promotes the softness of the copolymer. Alkyl radicals above this limiting value reduce the flexibility of the polymer chain to which they are bound and thus increase the hardness.

A strong influence on the softness is exercised by the acid anion of which the copolymer is a salt. While the anions of mineral acids and the lower organic sulfonic acids and carboxylic acids tend to increase the hardness of the copolymer, it has been found that the anions of higher carboxylic acids have a plasticizing action. This applies to carboxylic acids having at least four and particularly preferably 8 to 20 carbon atoms. Preferred carboxylic acids from this group are capric acid, lauric acid and myristic acid. If the necessary water-solubility is not achieved using these higher carboxylic acids, a mixture of higher and intermediate carboxylic acids or dicarboxylic acids, e.g. adipic acid, can be used. The proportion of intermediate carboxylic acids can be, for example, up to 30 mol % of the anionic equivalents.

Acid-Functionalized Copolymers (c):

It is known that the higher alkyl esters of acrylic and/or methacrylic acid make the copolymers produced therefrom soft and sticky. At the same time, they make the copolymer hydrophobic and insoluble in water.

When deciding the proportion of the monoethylenically unsaturated, free-radically polymerizable carboxylic acid, account therefore has to be taken of the desired solubility in water and, on the other hand, a sufficient proportion of the plasticizing alkyl acrylate or methacrylate has to be ensured. If the monomers used for forming the copolymer do not allow these two properties to be achieved simultaneously at any mixing ratio, recourse can be made to a plasticizer, i.e. component e). A sufficiently high proportion of free-radically polymerizable carboxylic acid enables, for example, water-based binder systems to be prepared. If a lower carboxylic acid content is chosen, solvent-based systems are obtained.

As solvents for the solvent-based systems, it is possible to use individual substances or mixtures selected from among alkyl alcohols (e.g. ethanol, isopropanol), ketones (e.g. acetone, MEK) and other solvents which can easily be removed. Sometimes it is also possible to use solvents which remain in the system, e.g. diols (1,2- or 1,3-propanediol, butanediol) or other polar solvents such as diglyme, etc.

The monoethylenically unsaturated, free-radically polymerizable monocarboxylic or dicarboxylic acid preferably has the structure

R—CH═CR′—COOY

where either R is a hydrogen atom or an alkyl group having 1-12 carbon atoms and R′ is a hydrogen atom, a methyl group or a —CH₂—COOH group or R is a —COOH group and R′ is a hydrogen atom. These carboxylic acids include acrylic and methacrylic acids, itaconic acid, maleic acid and fumaric acid. The proportion of monoethylenically unsaturated monocarboxylic or dicarboxylic acids is preferably 30-80% by weight, in particular 50-70% by weight, of the copolymer.

It is not absolutely necessary for all carboxylic acid units of the copolymer to be in the salt form, as long as the proportion is sufficient to ensure solubility in water. The proportion required for this depends on the size and hydrophobicity of the ester component. In some cases, a content of 15% by weight of carboxylate units is sufficient to make the copolymer soluble in water. In general, the content of carboxylate monomer units is from 20 to 50% by weight.

Water solubility of the polymer can be achieved by partial neutralization of the carboxyl groups present; the proportion neutralized is from 20 to 50 mol %, depending on the content of carboxylic acid monomer units. For practical purposes, degrees of neutralization of from 20 to 100 mol %, in particular from 50 to 100 mol %, are preferred. The electrical properties can be influenced by means of the degree of neutralization.

Examples of salt-forming cations Y are H⁺ and also alkali metal cations, in particular sodium and potassium. Other metal cations can be employed insofar as the crosslinking action due to polyvalent cations is desired (then rather as crosslinking agent). Organic ammonium cations are suitable if they are not given off in the form of the corresponding amine vapor on drying or during storage. It is possible to use, for example, quaternary ammonium cations such as tetramethylammonium or preferably ammonium cations derived from relatively involatile amines such as diethanolamine or triethanolamine, triisopropanolamine, diethanolbutylamine, and the like.

Among the alkyl esters of acrylic acid and/or methacrylic acid, preference is given to those having from 1 to 12 carbon atoms in the alkyl radical, especially the esters of acrylic acid. Methyl, ethyl, n-butyl, n-hexyl, n-octyl, 2-ethylhexyl, n-decyl and n-dodecyl acrylate are particularly suitable. The lower esters of acrylic and/or methacrylic acid are generally used only as comonomers in addition to the higher esters. Further comonomers can also be incorporated in the copolymer, as long as they do not reduce the desired solubility in water to an unacceptable extent or increase the hardness to an unacceptable extent. Examples are acrylamide and/or methacrylamide, hydroxyalkyl esters, co-methoxypolyalkylene glycol esters and polyalkylene glycol esters of acrylic acid and/or methacrylic acid, ethylene, vinyl acetate, vinyl propionate and vinylpyrrolidone. The concomitant use of these monomers is generally not necessary for the preparation of binders; they are usually present in a proportion of less than 20% by weight.

The copolymer can be produced in the salt form by free-radical copolymerization of the neutralized carboxylic acid with the other monomer constituents in aqueous solution. However, preference is given to firstly preparing the unneutralized copolymer by using the free monocarboxylic or dicarboxylic acid. The free-radical polymerization of these monomer mixtures can be carried out using various polymerization processes which have been known for a long time, e.g. polymerization in water or in organic solvents, polymerization in bulk and, since the copolymers in the acid form are less water-soluble, also emulsion polymerization in the aqueous phase. The organic polymer solutions and aqueous polymer dispersions can be converted into powder products by, for example, spray drying. The bulk polymers are melted in an extruder and extruded to produce fine granules.

Salt-Forming Components b) and d):

Interaction of the monofunctional, bifunctional or polyfunctional compounds with the component a) or c) to increase the salt concentration makes it possible to set particular electrical properties such as the resistivity, and also results in crosslinking and thus, in conjunction with the plasticizer component e), enables the glass transition temperature T_{g} to be set.

As monofunctional compounds b), it is possible to use, in conjunction with the amino-functionalized (meth)acrylate copolymer a), for example short-chain carboxylic acids such as acetic acid, lactic acid, propionic acid or benzoic acid.

The interaction of the components a and b is therefore as follows:

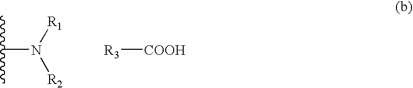

where

R¹, R²=for example methyl or ethyl,

R³=a branched or unbranched alkyl, hydroxyalkyl, cycloaliphatic or hydroxy-functionalized hydrocarbon chain having from 1 to 6 carbon atoms.

As monofunctional compound d), it is possible to use, in conjunction with the carboxyl-functionalized (meth)acrylate copolymers c), for example short-chain amines such as triethanolamine, diethanol-n-butylamine or triisopropanolamine.

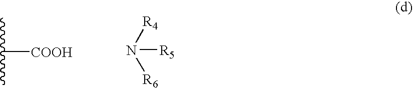

where R⁴, R⁵, R⁶=H, or a branched or unbranched alkyl, hydroxyalkyl, cycloaliphatic or hydroxy-functionalized hydrocarbon chain having from 1 to 6 carbon atoms.

As bifunctional compounds b), it is possible to use, in the case of the amino-functionalized (meth)acrylate copolymer a), for example succinic acid, propanedicarboxylic acid, adipic acid, dodecanedioic acid, etc.

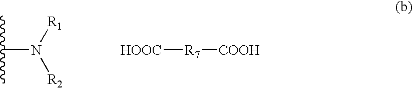

where

R¹, R²=for example methyl or ethyl,

R⁷=a branched or unbranched alkyl, hydroxyalkyl, cycloaliphatic or hydroxy-functionalized hydrocarbon chain having from 1 to 6 carbon atoms.

Bifunctional compounds d) which can be used in the case of the carboxyl-functionalized (meth)acrylate copolymer c) are short-chain tertiary diamines such as N,N′-dimethylethylenediamine, N,N,N′,N′-tetramethylethylenediamine, N,N,N′,N′-tetrakis(2-hydroxyethyl)ethylenediamine, N,N,N′,N′-tetrakis(2-hydroxyisopropyl)ethylenediamine.

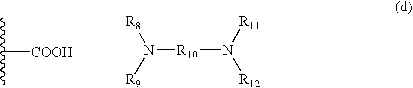

where

R⁸, R⁹, R¹⁰, R¹¹, R¹² are each, independently of one another, H, or a branched or unbranched alkyl, hydroxyalkyl, cycloaliphatic or hydroxy-functionalized hydrocarbon chain having from 1 to 6 carbon atoms.

Polyfunctional compounds b) which can be used in the case of the amino-functionalized (meth)acrylate copolymer a) are, for example, polyacids such as polyacrylic acid, EUDRAGIT® L or polystyrenesulfonic acid, polyamides, polyacrylamides and corresponding copolymers.

Polyfunctional compounds d) which can be used in the case of the carboxyl-functionalized (meth)acrylate copolymer c) are, for example, polyamines (PEI), polyamides or polyethylene glycols, poly(meth)acrylates, polyacrylamides or EUDRAGIT® E.

As components b) or d), preference is given to using propionic acid, benzoic acid, triethanolamine, succinic acid, adipic acid, dodecanedioic acid, polyacrylic acid, polystryrenesulfonic acid, polyamines (PEI), polyamides or polyacrylamides, alkyl citrates, glyceryl esters, alkyl phthalates, alkyl sebacates, sucrose esters, sorbitan esters, dibutyl sebacate and polyethylene glycols, triethyl citrate, acetyl triethyl citrate, poly(meth)acrylates, copolymers of ethyl acrylate and methyl methacrylate, copolymers of methyl methacrylate and butyl (meth)acrylate and/or 2-ethylhexyl methacrylate or copolymers of methyl acrylate and methyl methacrylate, N,N-dimethyl-n-octylamine, N, N-dimethyl-n-stearylamine, 1,4-bis(dimethylamino)butane, amino-terminated polyethylene oxide, ω-carboxyl-functionalized PEO systems or PEO-dicarboxylic acid oligomers and polyesters.

Component e)

Materials suitable as plasticizer component e) for the amino-functionalized (meth)acrylate copolymers a) and for the carboxyl-functionalized (meth)acrylate copolymers d) can be divided into the following groups:

1. Compounds without free functional groups capable of reacting with the functional groups of the component a): these generally have a molecular weight of from 100 to 20 000 g/mol and have one or more hydrophilic groups in the molecule, e.g. hydroxyl, ether or ester groups. Examples of suitable plasticizers are alkyl citrates, glyceryl esters, alkyl phthalates, alkyl sebacates, sucrose esters, sorbitan esters, dibutyl sebacate and polyethylene glycols having a molecular weight of from 4 000 to 20 000 dalton. Preferred plasticizers are, for example, triethyl citrate and acetyl triethyl citrate.

2. Poly(meth)acrylates without or with only insignificant amounts of functional groups, whose dynamic glass transition temperatures in accordance with DIN 53445 are in the range from −70 to about 80° C. Examples of such polymers are copolymers of ethyl acrylate and methyl methacrylate, preferably containing more than 30% by weight of ethyl acrylate, or copolymers of methyl methacrylate with butyl (meth)acrylate and/or 2-ethylhexyl methacrylate or copolymers of methyl acrylate and methyl methacrylate. Further copolymerized monomers such as hydroxyalkyl esters and polyalkylene glycol esters of acrylic and/or methacrylic acid and vinylpyrrolidone may also be present to generate the solubility in water.

3. Compounds without free functional groups capable of reacting with the functional groups of the component a): these generally have a molecular weight of from 100 to 20 000 g/mol and have one or more lipophilic groups in the molecule, e.g. ester or ether groups. Examples of suitable plasticizers are alkyl citrates, glyceryl esters, alkyl phthalates, alkyl sebacates, sucrose esters, sorbitan esters, dibutyl sebacate and polyethylene glycols having a molecular weight of from 4 000 to 20 000 dalton. Preferred plasticizers are, for example, triethyl citrate and acetyl triethyl citrate.

4. Poly(meth)acrylates without or with only insignificant amounts of functional groups, whose dynamic glass transition temperatures in accordance with DIN 53445 are in the range from −70 to about 80° C. Examples of such polymers are copolymers of ethyl acrylate and methyl methacrylate, preferably containing more than 30% by weight of ethyl acrylate, or copolymers of methyl methacrylate with butyl (meth)acrylate and/or 2-ethylhexyl methacrylate or copolymers of methyl acrylate and methyl methacrylate.

5. Monofunctional, bifunctional or polyfunctional compounds, which, in addition to the functional group capable of undergoing a salt-forming reaction with a complementary group of the amino-functionalized (meth)acrylate copolymers a), also contain a relatively long aliphatic structural unit, and are at the same time soluble in water. Appropriate salt-forming carboxylic acids are described in DE 39 24 393.

6. Monofunctional, bifunctional or polyfunctional compounds, which, in addition to the functional group capable of undergoing a salt-forming reaction with a complementary group of the amino-functionalized (meth)acrylate copolymers a), also contain a relatively long aliphatic structural unit and have a lipophilic character. Appropriate salt-forming carboxylic acids are described in DE 39 24 393.

7. Monofunctional, bifunctional or polyfunctional compounds which, in addition to the functional group capable of undergoing a salt-forming reaction with a complementary group of the carboxyl-functionalized (meth)acrylate copolymer c), also contain a relatively long aliphatic structural unit, and are at the same time soluble in water. Salt-forming amines are described in DE 39 13 734, and it is also possible to use tertiary amines having a maximum of two long alkyl chains (>C6), e.g. N,N-dihydroxyethyl-n-octylamine, N,N-dihydroxyethyl-n-stearylamine, N,N′-dihydroxyethyl-n-dodecylamine. Long-chain tetra-2-hydroxyethyldiamines or tetra-2-hydroxypropyldiamines can likewise be used. Short-chain bifunctional tetrahydroxyethyldiamines or tetra-2-hydroxypropyldiamines tend to have a stiffening character rather than a plasticizing effect.

8. Monofunctional, bifunctional or polyfunctional compounds which, in addition to the functional group capable of undergoing a salt-forming reaction with a complementary group of the carboxyl-functionalized (meth)acrylate copolymer c), also contain a relatively long aliphatic structural unit and have a lipophilic character. Salt-forming amines are described in DE 39 13 734, and it is also possible to use tertiary amines having an alkyl chain (>C6), e.g. N,N-dimethyl-n-octylamine, N,N-dimethyl-n-stearylamine, N,N′-dimethyl-n-dodecylamine. Long-chain tetramethyldiamines, tetraethyidiamines or tetrapropyldiamines can likewise be used. Short-chain bifunctional tetramethyldiamines such as 1,4-bis(dimethylamino)butane tend to have a stiffening character rather than a plasticizing effect.

9. For water-based systems, it is possible to use water-soluble, salt-forming plasticizers such as ω-carboxyl-functionalized polyethylene oxide (PEO) systems or PEO-dicarboxylic acid oligoesters and polyesters which undergo a salt-forming reaction with the complementary group of the amino-functionalized (meth)acrylate copolymers a).

10. For water-based systems, it is possible to use water-soluble, salt-forming plasticizers such as amino-terminated polyethylene oxide (e.g. Jeffamine (DuPont)) which undergo a salt-forming reaction with the complementary group of the carboxyl-functionalized (meth)acrylate copolymers c).

11. Hydrophilic systems having a complex composition, e.g. the reaction product of either an excess of one or more dicarboxylic acid(s) and one or more, unfunctionalized or hydroxy-functionalized tertiary monoamine(s) having long aliphatic or cycloaliphatic radicals or an excess of one or more dicarboxylic acid(s) and one or more, unfunctionalized or hydroxy-functionalized tertiary diamine(s) having long middle segments composed of alkylene radicals or PEO, for the group consisting of amino-functionalized (meth)acrylate copolymers a).

12. Hydrophilic systems having a complex composition, e.g. the reaction product of either an excess of one or more, unfunctionalized or hydroxy-functionalized tertiary diamine(s) and one or more monocarboxylic acid(s) having a long alkyl radical, or an excess of one or more, unfunctionalized or hydroxy-functionalized tertiary diamine(s) and one or more dicarboxylic acid(s) having long middle segments composed of alkylene radicals or PEO, for the carboxyl-functionalized (meth)acrylate copolymers c).

13. Lipophilic systems having a complex composition, e.g. the reaction product of either an excess of one or more dicarboxylic acid(s) and one or more, unfunctionalized or hydroxy-functionalized tertiary monoamine(s) having long aliphatic or cycloaliphatic radicals or an excess of one or more dicarboxylic acid(s) and one or more tertiary diamine(s) having long middle segments composed of alkylene radicals, for the group consisting of amino-functionalized (meth)acrylate copolymers a).

14. Lipophilic systems having a complex composition, e.g. the reaction product of either an excess of one or more tertiary diamine(s) and one or more monocarboxylic acid(s) having a long alkyl radical, or an excess of one or more tertiary diamine(s) and one or more dicarboxylic acid(s) having long middle segments composed of alkylene radicals, for the carboxyl-functionalized (meth)acrylate copolymers c).

1. A mixture comprising one or more (meth)acrylate polymers functionalized by sulfonate, carboxylate or quaternary amino groups and an ionic liquid where the ionic liquid used is a salt having a cation selected from the group consisting of imidazolium ions pyridinium ions or, ammonium ions of the following structures, 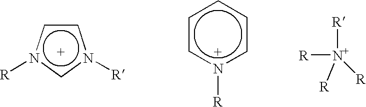
where R, R′=H, identical or different alkyl, olefin or aryl groups, with the proviso that R and R′are different, and an anion selected from the group consisting of BF₄⁻ ions, alkylborate ions, BEt₃Hex ions where Et=an ethyl group and Hex=a hexyl group, halophosphate ions, PF₆⁻ ions, nitrate ions, sulfonate ions, alkylsulfonate and arylsulfonate ions, hydrogensulfate ions and chloroaluminate ions or a salt with a cation selected from phosphonium ions of the following structure. 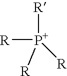
where R, R′=H, identical or different alkyl, olefin or aryl groups, with the proviso that R and R′ are different, and an anion selected from the group consisting of BF₄⁻ ions, alkylborate ions, BEt₃Hex ions where Et=an ethyl group and Hex=a hexyl group, halophosphate ions, PF₆⁻ ions, nitrate ions, hydrogensulfate ions and chloraluminate ions.

2. A mixture as claimed in claim 1 wherein the (meth)acrylate polymer is a copolymer of at least one (meth)acrylate monomer and at least one olefinically unsaturated monomer.

3. A mixture as claimed in either of claims 1 and 2, wherein the (meth)acrylate polymer functionalized by quaternary amino groups is obtained by reacting a (meth)acrylate polymer functionalized by tertiary amino groups with an acid.

4. A mixture as claimed in either of claims 2 and 3, wherein the olefinically unsaturated monomer is functionalized by tertiary amino groups.

5. A mixture as claimed in either of claims 3 and 4, wherein the (meth)acrylate polymer functionalized by quaternary amino groups is obtained by reacting a (meth)acrylate polymer functionalized by tertiary amino groups with an organic monofunctional, bifunctional, trifunctional or polyfunctional carboxylic acid.

6. A mixture as claimed in either of claims 1 and 2, wherein the (meth)acrylate polymer functionalized by carboxylate groups is obtained by reacting a (meth)acrylate polymer functionalized by carboxyl groups with an amino compound.

7. A mixture as claimed in claim 6, wherein the olefinically unsaturated monomer is functionalized by carboxylate groups.

8. A mixture as claimed in either of claims 6 and 7, wherein the (meth)acrylate polymer functionalized by carboxylate groups is obtained by reacting a (meth)acrylate polymer functionalized by carboxyl groups with an organic monofunctional, bifunctional, trifunctional or polyfunctional amine compound.

9. A mixture as claimed in any of claims 6 to 8, wherein the (meth)acrylate polymer functionalized by sulfonate groups is obtained by reacting a (meth)acrylate polymer functionalized by sulfonic acid groups with an amino compound.

10. A mixture as claimed in claim 9, wherein the olefinically unsaturated monomer is functionalized by sulfonic acid groups.

11. A mixture as claimed in either of claims 9 or 10, wherein the (meth)acrylate polymer functionalized by sulfonate groups is obtained by reacting a (meth)acrylate polymer functionalized by sulfonic acid groups with an organic monofunctional, bifunctional, trifunctional or polyfunctional amine compound.

12. The use of a mixture as claimed in any of claims 1 to 11 in electrical and electronic components.

13. The use of a mixture as claimed in any of claims 1 to 11 for the processing of polymers by extrusion.

14. The use of a mixture as claimed in any of claims 1 to 11 in the processing of polymers by injection molding.
